(19) United States
(12) Patent Application Publication
(10) Pub. No.: US 2002/0002541 A1
(43) Pub. Date: Jan. 3, 2002

(54) Online digital content library

(76) Inventor: Eddie H. Williams, Fountain Hills, AZ (US)

Correspondence Address: Brett A. Carlson, Snell & Wilmer L.L.P., One Arizona Center, 400 East Van Buren, Phoenix, AZ, 85004-2202, US

(21) Appl. No.: 09/895,900

(22) Filed: Jun. 29, 2001

Related U.S. Application Data
(60) Provisional application No. 60/215,463, filed on Jun. 30, 2000.
(60) Provisional application No. 60/224,112, filed on Nov. 20, 2000.

(51) Int. Cl. G06F 17/60

(52) U.S. Cl. 705/51

(57) ABSTRACT

According to various exemplary embodiments, a system for distributing digital content via a digital network suitably includes a database configured to receive the digital content from the input and to store the content in a database, an interface to the digital network, and an application program configured to receive a request for the digital content from a user via the interface and to process the request such that the user is granted access to the digital content for a limited period of time. Other aspects of the invention include methods for distributing online content, methods for operating an online library, and the like.

### FIELD OF INVENTION

The invention relates generally to systems and methods for distributing online digital content. More particularly, the invention relates to a library system for distributing digital content (such as music) and to various methods for distributing digital content.

### BACKGROUND OF THE INVENTION

Consumers have purchased music, movies, books and other forms of information and entertainment in various formats for many years. Musical content, for example, has been available for several decades on various forms of digital and analog audio tape, vinyl LP records, compact disks, and the like. Similarly, movies and other forms of audio/visual (AN) content have been distributed via analog tape, various forms of digital laser disks, and the like.

With the advent of digital networks such as the Internet, consumers have increasingly demanded distribution of audio and AN content via such networks to facilitate immediate on-demand delivery, among other things. In response to this consumer demand, services such as the NAPSTER online MP3 distribution service have made great amounts of digital content widely available at no cost to the consumer.

Copyright owners (such as artists, record labels, motion picture producers, and the like) have alleged, however, that copyright violations and piracy have become rampant on such services. Litigation has ensued between several online services and copyright owners which has resulted in severely curtailed availability of content, especially content that is in high demand. A system of distributing online content such as music and AN content that acknowledges both consumer demand and the intellectual property rights of suppliers is therefore greatly desired.

### SUMMARY OF EXEMPLARY EMBODIMENTS

According to various exemplary embodiments, a system for distributing digital content via a digital network suitably includes a server configured to receive the digital content and to store the content in a file system and/or database, an interface to the digital network, and an application program configured to receive a request for the digital content from a user via the interface and to process the request such that the user is granted access to the digital content for a limited period of time. Other aspects of the invention include methods for distributing online content, methods for operating an online library, and the like.

### BRIEF DESCRIPTION OF THE DRAWING FIGURES

The above and other features and advantages of the present invention are hereinafter described in the following detailed description of illustrative embodiments to be read in conjunction with the accompanying drawing figures, wherein like reference numerals are used to identify the same or similar parts in the similar views, and:

FIG. 1 is a block diagram of an exemplary library system for distributing content via a digital network; FIG. 2 is a flowchart for an exemplary library process;

FIG. 3A is a block diagram of an exemplary library server system;

FIG. 3B is a block diagram of an exemplary library server application;

FIG. 4 is a flowchart of an exemplary process for uploading data to a library system;

FIG. 5 is a flowchart of an exemplary process for retrieving files in an exemplary library system;

FIG. 6 is a flowchart of an exemplary process executed by an exemplary client program; and

FIGS. 7A-E are exemplary user interfaces for a library distribution system.

### DESCRIPTION OF EXEMPLARY EMBODIMENTS

Various aspects of the present invention may be described herein in terms of functional block components and various processing steps. It should be appreciated that such functional blocks may be realized by any number of hardware and/or software components configured to perform the specified functions. For example, the software elements described herein be implemented with any programming or scripting language such as C, C++, PASCAL, Java, assembler, PERL, PHP, any database programming language or the like, and the various algorithms may be implemented with any combination of data structures, objects, processes, routines or other programming elements. Similarly, the invention could be used in conjunction with any type of personal computer, network computer, workstation, minicomputer, mainframe, or other computer running any version of Windows, MacOS, BeOS, Linux, UNIX, Solaris or any other operating system. Further, the present invention might employ any number of conventional techniques for data transmission, signaling, data processing, network control, and the like. For example, radio frequency (RF) or other wireless techniques could be used in place of any network technique described herein. Moreover, although the invention is frequently described herein as being implemented with TCP/IP communications protocols, it will be readily understood that the invention could also be implemented using IPX, Appletalk, IP3, IP-6, NetBIOS, OSI or any number of existing or future protocols. Further, the term “Internet” may refer to the Internet, any replacement, competitor or successor to the Internet, or any public or private internetwork, intranet, extranet or other digital network that is based upon open or proprietary protocols. Specific information related to the protocols, standards, and application software utilized by in connection with the Internet may not be discussed herein. For further information regarding such details, see, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997). LOSHIN, TCP/IP CLEARLY EXPLAINED (1997). All of these texts are hereby incorporated by reference. Additionally, the term “web page” as it is used herein is not meant to limit the type of documents and applications that might be used to interact with the user. For example, a typical website might include, in addition to standard HTML documents, various forms, Java applets, Javascript, active server pages (ASP), common gateway interface scripts (CGI), extensible markup language (XML), dynamic HTML, cascading style sheets (CSS), helper applications, plug-ins, and the like.

The particular implementations shown and described herein are illustrative of the invention and are not intended to limit the scope of the invention in any way. Indeed, for the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections might be present in a practical online library system. To simplify the description of the exemplary embodiments, the invention is frequently described as pertaining to a system of providing an online library for digital music. It will be appreciated, however, that many applications of the present invention could be formulated. For example, the present invention could be used to promote or distribute any type of digital information such as music, spoken word, audio, video, AN, still photographs, holographic photographs, stereoscopic photographs, digital images, multimedia content, electronic books, audio books, video games, sheet music, lyrics, guitar tabulature, executable files, data files, textual data or the like.

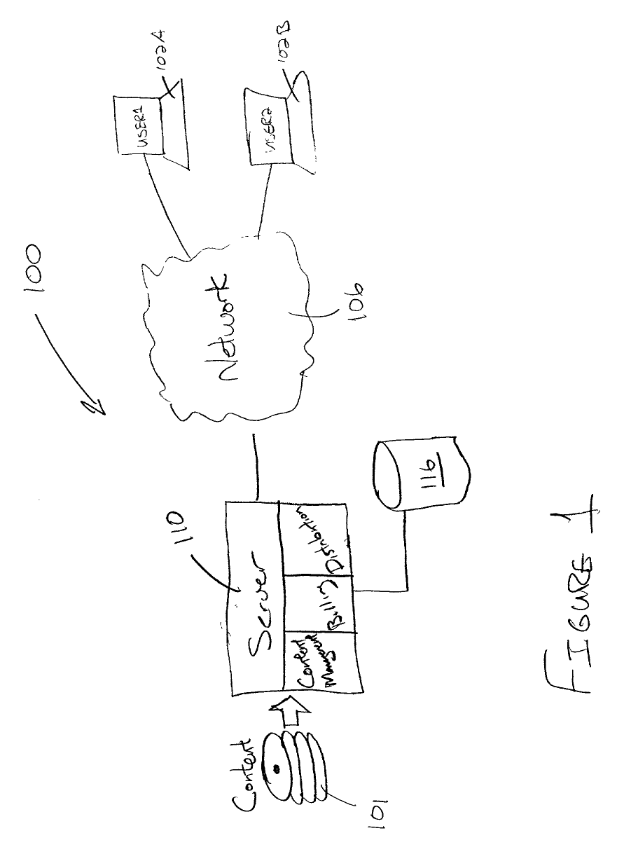

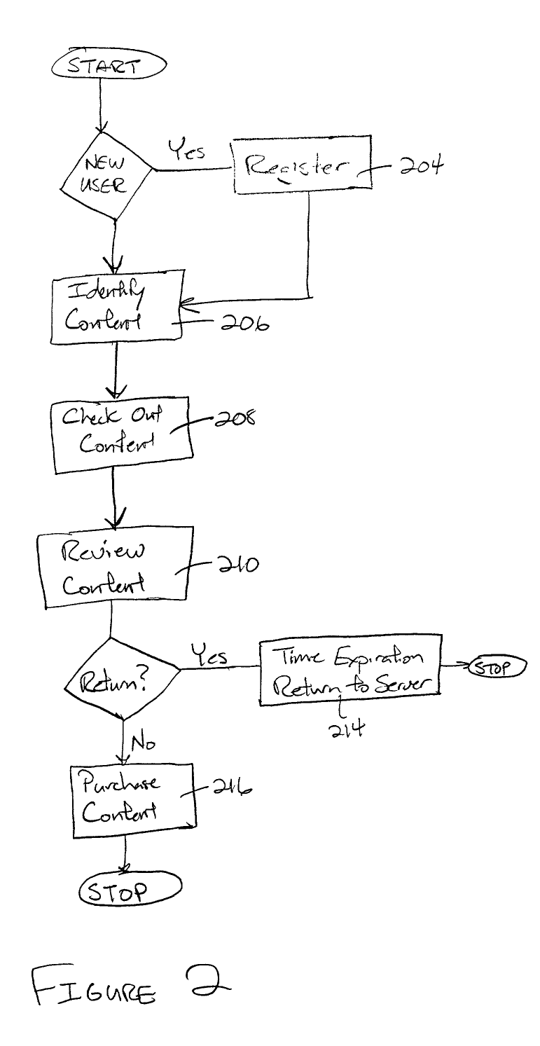

FIG. 1 is a block diagram of an exemplary library system 100. With reference to FIG. 1, a number of client systems 102 communicate with a library system 110 (also referred to as a “library server”) via a network 106 to send and/or receive data, such as HTML documents (i.e. web pages). Library server 110 suitably maintains web pages or other digital content in any conventional manner. In various embodiments, library server 110 is a conventional server on the Internet that provides content (e.g. web pages) to various client systems 102 via the HTTP protocol (or the like) as requested by users of client systems 102. Users suitably view content provided by library server 130 via a conventional browser, or the like, as described below. Of course many library servers 110 may be coupled to network 106, and users of client systems 102 may access web pages and other content from multiple library servers 110.

User systems 102 may include any convenient combination of hardware and software components configured to allow a user to communicate with over network 106. For example, user system 102 might include a standard personal computer (PC) including a CPU, monitor, storage, keyboard, mouse, and communication hardware appropriate for the given data link 104 (e.g., V.90 modem, network card, cable modem, etc.). User system 102 might also include one or more peripheral devices such as a scanner, a digital camera, a motion video camera, a TV tuner card, or the like. In alternate embodiments, user system 102 is a personal data assistant (PDA) capable of manipulating images and communicating with server 110. In yet another embodiment, user system 102 is a kiosk located at a mall, theme park, post office, street, airport, or any other location.

User systems 102 will typically include an operating system (e.g., Windows 95/98/2000, Linux, Solaris, MacOS, etc.) as well as various conventional support software modules and drivers typically associated with computers. User system 102 may also include application software configured to communicate over network 106 with server 110, for example, a World Wide Web (WWW) browser or any other communication software. In an exemplary embodiment, user system 102 includes a conventional Internet browser application that operates in accordance with HTML and HTTP protocols such as Netscape Navigator (available from the Netscape Corporation of Mountain View, Calif.) or Microsoft Internet Explorer (available from the Microsoft Corporation of Redmond, Wash.).

Client systems 102, and library server 110 are suitably coupled to network 106 via data links, as appropriate. A variety of conventional communications media and protocols may be used for these data links. Such links might include, for example, a connection to an Internet Service Provider (ISP) over a local loop as is typically used in connection with standard modem communication, cable modem, dish networks, ISDN, Digital Subscriber Line (DSL), or various wireless communication methods. User system 102 might also reside within a local area network (LAN) which interfaces to network 106 via a leased line (T1, D3, etc.).

Such communication methods are well known in the art, and are covered in a variety of standard texts. See, e.g., GILBERT HELD, UNDERSTANDING DATA COMMUNICATIONS (1996), hereby incorporated by reference.

Library server 110 suitably includes any number of hardware, software, and networking components necessary to provide a suitable website or other network-based interface that is accessible by users, and which provides the functionality described in further detail below. In one embodiment, Sun Ultra SPARC Enterprise 250 and 450 servers are used in conjunction with a Sun Solaris 7 or Linux operating system, Apache web server software, and an Oracle 8 or MySQL database system. Of course particular hardware and software components used in server 110 will vary widely from embodiment to embodiment. Furthermore, server 110 may represent a “cluster” or group of separate computer systems providing the functionalities described herein. In various embodiments, server 110 includes a suitable interface to network 106 such as a network interface card (NIC) and/or appropriate data networking software such as an implementation of the TCP/IP stack, or the like. Of course, server 110 is not necessarily directly connected to network 106, but may be coupled to network 106 though any system of cabling, bridges, routers, gateways, data links, and the like.

Server 110 may suitably maintain digital media files in a database 116. Database 116 may be a graphical, hierarchical, relational, object-oriented or other database, and may be maintained on a local drive of server 110 or on a separate computer coupled to server 110 via a local area or other network (not shown). In alternate embodiments, database 116 is represented by a collection of files stored on a local drive of server 110. Content may be suitably retrieved from database 116 and provided to user systems 102 upon request via a server software application, as described more fully below. Content may be stored in any format such as MPEG, MP3, MP4, GIF, .JPG, AAIFF, AU, .WAV or any other format.

Llbrary server 110 may be configured as a conventional Internet or WWW server that provides data via the hypertext transport protocol (HTTP). With continued reference to FIG. 1, digital or analog content may be sampled, “ripped” or otherwise converted to digital format for storage in database 116. Such content may then be made available via network 106 (e.g. the Internet or World Wide Web) to user systems 102. Various restriction schemes may be placed on content that is distributed to user systems 102.

FIG. 2 is a flowchart of an exemplary process 200 for operating an online music library. With reference now to FIG. 2, an exemplary process 200 suitably includes registering new users (step 204), identifying content for distribution (step 206), checking out content (step 208), and returning content (step 212) after the user has reviewed the content (step 210).

New users may be registered by obtaining contact information (e.g. name, address, email address, and the like), optional demographic information (location, age, income, profession, and the like) and/or payment information (e.g. a credit card or debit card number). This information may be stored in a database (such as database 116 or any other database) in communication with server 110 for further processing. A registration fee may be charged to the user in various embodiments. For example, a sign up charge of, for example, ten dollars may be charged for the use of a library.

After a user is signed up for the library service, they are permitted to “check out” songs, MP3 files, or other content by browsing or otherwise perusing an interface to server 110. Users may be billed for each item that they “check out” in various embodiments, or, alternatively, there may be no charge for registration and/or check out.

In an exemplary embodiment, an administrator purchases a number of copies of compact disks, DVDs, mini-disks or other recorded media, and the content from these purchased items is converted to digital format or otherwise made available for checkout on library server 110. In one embodiment, the total number of copies of each piece of content that is available for checkout to library users is limited to the number of actual compact disks, DVDs, or the like that are purchased by the library administrator. Alternatively, a library administrator may enter into license agreements with content distributors that permit the administrator to “check out” a certain number of copies of any particular work. In still other embodiments, a library administrator may enter into a license agreement with a content provider or other entity that allows the library access to an unlimited number of copies that may be available for checkout.

After users check out the content, they may be permitted to listen, view, play or otherwise peruse the content as appropriate. In an exemplary embodiment, the user is only allowed to use the content for a limited period of time, after which the content must be “returned” to the library. At the time that the content is “due” (which may be any period of time, such as 3 days, 2 weeks, 1 month, or any other period of time), the user may be prompted (via email, instant message or the like) to “return” the content. Alternatively, users may be responsible to track their own due dates.

“Returning” may be a manual process by the user whereby a user contacts library server 110 (or another server on network 106) and certifies that the relevant content has been disabled or destroyed. Alternatively, “return” may entail the use of technological means that limits serial copies of the content and/or disables use of the content after the due date. This automatic return may be accomplished through any number of hardware or software controls. For example, MP3 and other files containing content may be pre-programmed to become encrypted, scrambled, erased or otherwise disabled after a set date.

If the user does not “return” the content (either manually or through automatic return), the user may be billed for the value of the content in various embodiments. For example, if the content is not “returned” to server 110 by the due date, server 110 may bill the user for the price of a compact disk, DVD or the like using the payment information obtained, for example, in step 204. In this manner, digital content can be provided to many users via a digital network while limiting the amount of piracy or illegal distribution of the content. The interests of the consumer and of the content creators are both addressed through an efficient solution.

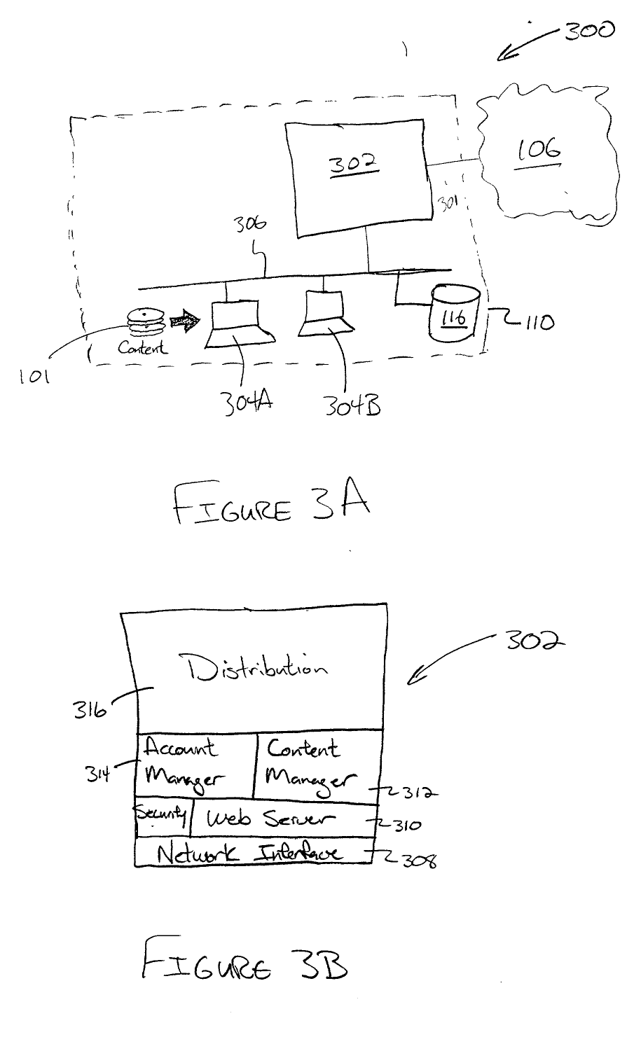

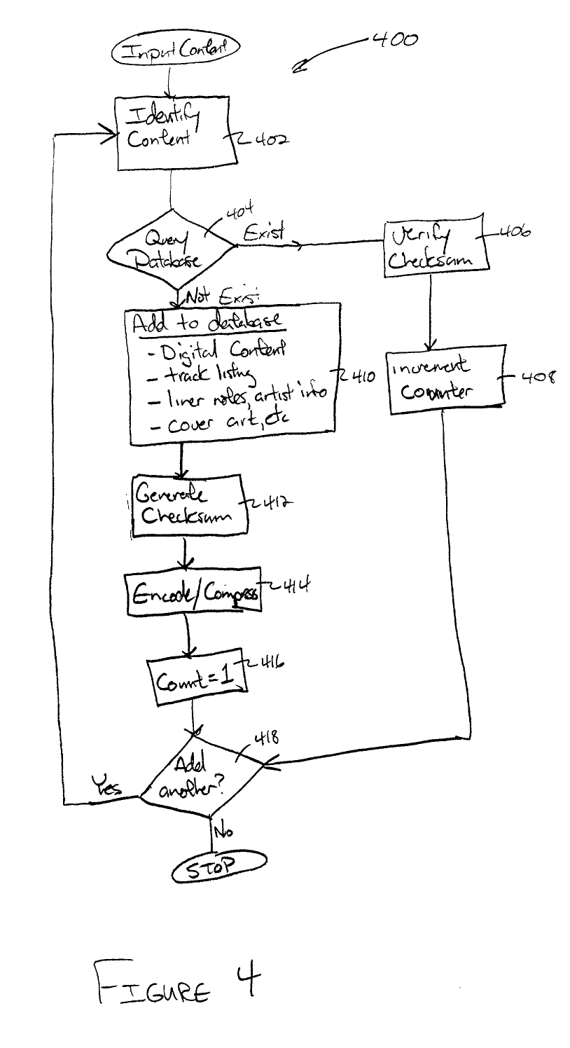

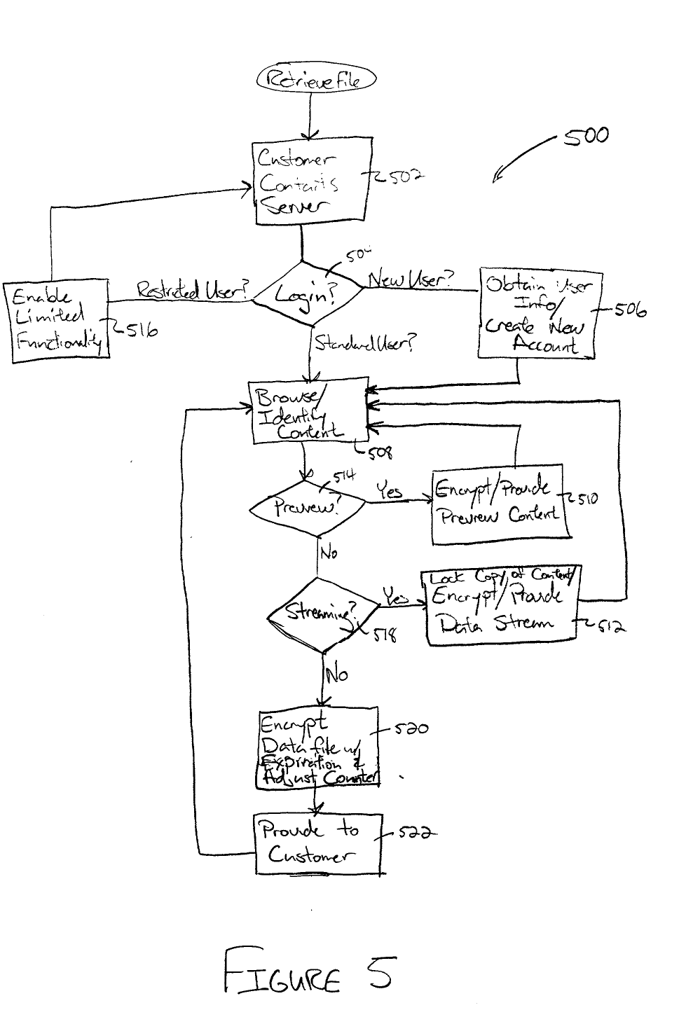

FIG. 3A is a block diagram of a more-detailed exemplary embodiment of a server system appropriate for use with a digital library. With reference now to FIG. 3, a server system 300 suitably includes a server application 302, a database 116, one or more workstations 304A-B for uploading content 101 to database 116, and an interface 301 to digital network 106. Server application 302 may be logically coupled with workstations 304A-B and/or database 116 via optional network 306, which may be any sort of LAN, WAN or other network. In an exemplary embodiment, network 306 is implemented with ETHERNET networking technologies. Workstations 304A-B may be implemented with any computer or workstation such as any workstation running the LINUX or WINDOWS operating systems. Such workstations may be configured with hardware and software for reading compact disks or other media 101 and for converting the content stored on media 101 to an appropriate format, as described more fully below.

FIG. 3B is a block diagram of an exemplary server application program for a digital library system. With reference now to FIG. 3B, an exemplary server application 302 suitably executes on a workstation or other computer such as a computer running any version of the LINUX, UNIX or WINDOWS operating systems. Such a system typically includes a CPU, memory, disk drive, network interface, and the like (not shown). Server application 302 and its various components may be stored in digital memory on a server computer, on a disk drive, on a CD-ROM or other portable storage media, or on any other type of digital storage medium.

Although various embodiments of server application 302 vary widely, an exemplary embodiment suitably includes an interface 308 to network 106 (FIG. 3A), a web server module 310 that includes security functionality as appropriate, a content manager module 312 that suitably interfaces to database 116 (FIG. 3A), an account manager, and a distribution module 316. In an exemplary embodiment, network interface 308 suitably facilitates communication between server application 302 and other applications running on separate workstations across network 106 and/or network 306. Such functionality may use operating systems calls or other resources associated with the operating system. Web server 310 may be implemented with any conventional HTTP Internet server software such as the Apache server product, or the like. Such programs typically include security mechanisms for limiting access to data in application 302 and to data travelling across networks 106 and 306 from server 302.

Many of the functions that are executed by an Internet library system are implemented by one or more of modules 312, 314 and/or 316. Each of these modules is made of up objects, routines, data structures and the like that are suitably configured to process information and to carry out tasks associated with the server application 302, such as the various processes described herein. Of course, in a practical server 302 functionality may be divided between many additional modules, and the functionalities carried out by server 302 may be carried out by different modules or in different manners than described herein. It will be appreciated, then, that the three modules shown in FIG. 3B are for illustrative purposes only, and may not be physically or logically found in all embodiments.

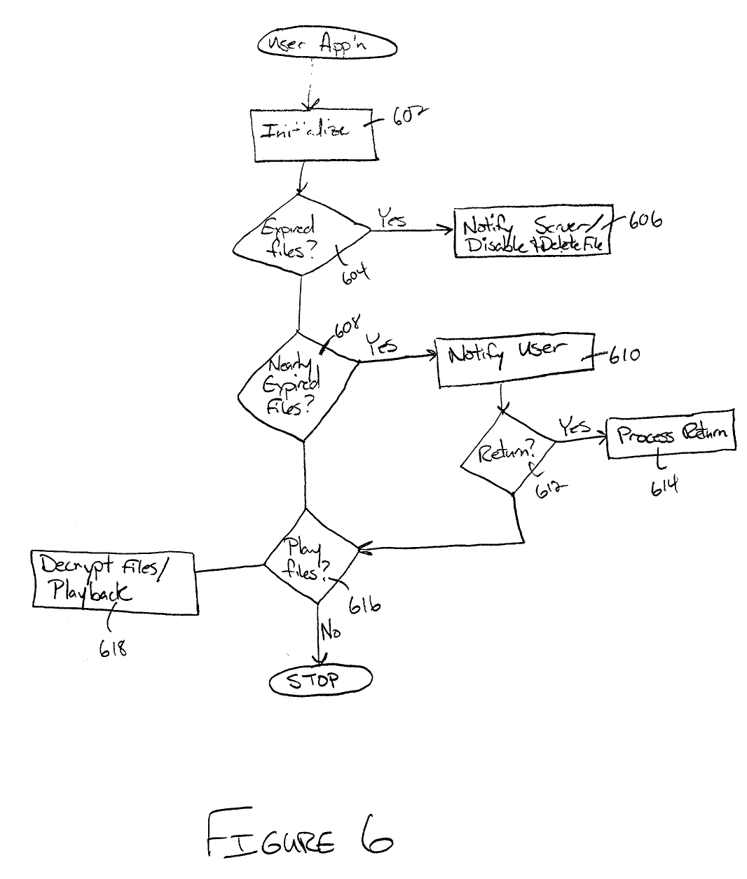

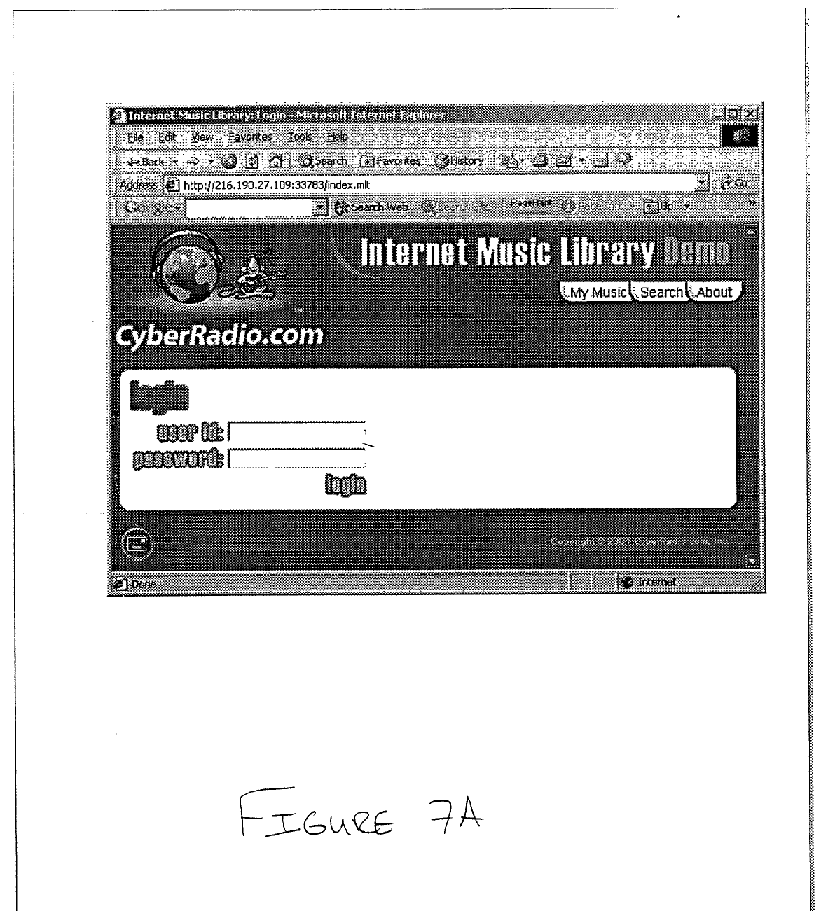

Content management module 312 suitably includes objects, routines and other executable code for managing content stored in database 116 (FIG. 3A). Account manager module 314 suitably includes objects, routines and the like configured for managing user and/or administrator accounts with application 302. In an exemplary embodiment, account module 314 makes use of security functionality included within web server 310 to restrict and control access to other modules, as appropriate. Distribution module 316 suitably includes objects and routines for administering and operating a functional library application program 302. Such routines may include coordinating the operations of other modules, tracking data, processing user interface data, and the like. Again, the particular functionalities handled by the various modules may vary widely from embodiment to embodiment. Exemplary processes performed by various embodiments of library server 302 are shown in FIGS. 4-6.

FIG. 4 is a flowchart of an exemplary process for loading data into a library system 300. Such a process may involve interaction between server application 302 (and in particular content manager module 312) and a client application executing on a workstation 302 (FIG. 3A) via network 316. In such embodiments, functionality may be split between multiple processors communicating in a client-server, master-slave or other manner. Alternatively, data may be directly uploaded at the workstation running application 302, or at any other workstation. The process shown in FIG. 4 assumes that content is being “ripped” or otherwise retrieved from a portable media such as a compact disk. In other embodiments, content may be received directly in a digital format (via network 106, for example, or via a CD-ROM) in a format that is ready for distribution. In such embodiments, the process shown in FIG. 4 and described below may be substantially modified or even eliminated.

With reference now to FIG. 4, an exemplary process 400 suitably begins by receiving a compact disk, DVD or other item of content 101 at a workstation for processing. In various embodiments, the workstation is one of the client workstations 304A-B shown in FIG. 3A. The content 101 is read by the workstation, which then attempts to identify the particular content (step 402). Identification may take place by reading a serial number or other code on the content item 101 that identifies the title, brand, or supplier of content item 101. Alternatively, content item 101 may be identified by scanning a barcode or similar identifier on item 101. In various embodiments, a query using the compact disk database (CDDB) or another suitable format may be made to a database residing on network 106 or 306 to determine Artist, Title, Song Listing or other information.

After identifying information is retrieved from content item 101, the workstation suitably queries database 116 to determine whether the content from item 101 is already stored therein (step 404). Database queries may be in any proprietary or open format such as the structured query language (SQL), or in any other format. If the content is not yet stored in database 116, then the workstation suitably processes content item 101 to convert the content to an appropriate digital format for storage in database 116 (step 410). Step 410 may additionally include obtaining information such as track listings, artist information, liner notes, cover art, and the like. Such information may be obtained from online databases, through manual entry or scanning, or from any other source, and may be stored in database 116 or elsewhere as appropriate. Conversion takes place with any suitable conversion utility, “ripper” application or the like. In an exemplary embodiment, music data from a compact disk may be “ripped” to an MP3, or similar format, although of course any other media format such as .VQF, AMC, AIFF, AU, .WAV, MIDI, or the like could be used. In alternate embodiments, music data is ripped to an OGG Vorbis format. Information about the OGG Vorbis project is available at http://www.xiph.org/ogg/vorbis/index.html. In still other embodiments, content items 101 are ripped to a raw digital extraction of the .wav data commonly stored on a compact disk. In such embodiments, the extracted .wav data may be stored in a directory or elsewhere within server system 300 for subsequent encoding and/or compression. Such embodiments may reduce the time for each workstation 304 to process a single content item 101, and may facilitate optimization between workstations 304A-B such that certain workstations may be allocated to rip data while other workstations 304A-B may be allocated to compression/encoding. Alternatively, each of the workstations 302A-B may concentrate on ripping data in a raw format that may then be stored in a directory accessible to server application 304 such that encoding/compression is suitably administered by content manager module 312 or another appropriate module of application 302.

When digital information is extracted from content item 101, a checksum or other digital identifier is generated as appropriate (step 412).

The checksum may be a cyclic reduction code (CRC), a digest computed with any algorithm such as the MD3 or MD4 algorithms available from RSA Technologies Inc., or according to any other checksum algorithm. The checksum may be computed on some or all of the content obtained from item 101. For example, the checksum may only cover the first song, the first 10 seconds of content, the first minute of content, or any other measure. The checksum serves to identify the content with a high level of certainty so that subsequent duplicate items may be identified. After the checksum is computed, ripped content may be encoded, compressed and/or otherwise processed as appropriate (step 414). As described above, various embodiments will encode raw data from the content items 101 into MP3, Vorbis or another format. Such processing maybe conducted by any of workstations 304A-B, by one or more modules of server application 302, or by another processor. Compressed/processed results may then be stored in database 116, as appropriate. As described above, various embodiments suitably maintain an accounting of a number of copies of each content item 101 available for borrowing. Such an accounting suitably includes a counter that may be initialized as appropriate (step 416).

After processing of an item 101 is complete, processing suitable repeats (step 418) if other content items remain. If duplicate items are identified in subsequent processing (step 404), a checksum may be computed based upon the duplicate item according to the same routine used in step 412 above. If the checksums for the two items match, system 300 can be relatively certain that the two items are duplicates. In such cases the counter initialized in step 416 may be incremented, as appropriate (step 408), and processing may continue. There may be no need to completely rip the contents of the duplicate item 101 because a prior copy of the contents has already been stored in database 116 and duplicity has been suitably verified by the checksum.

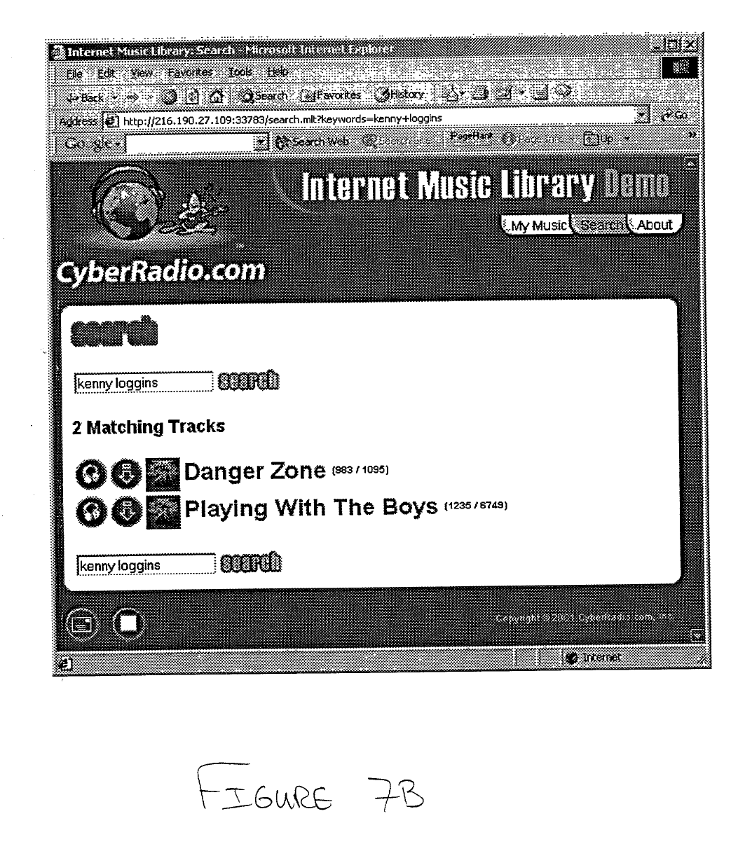

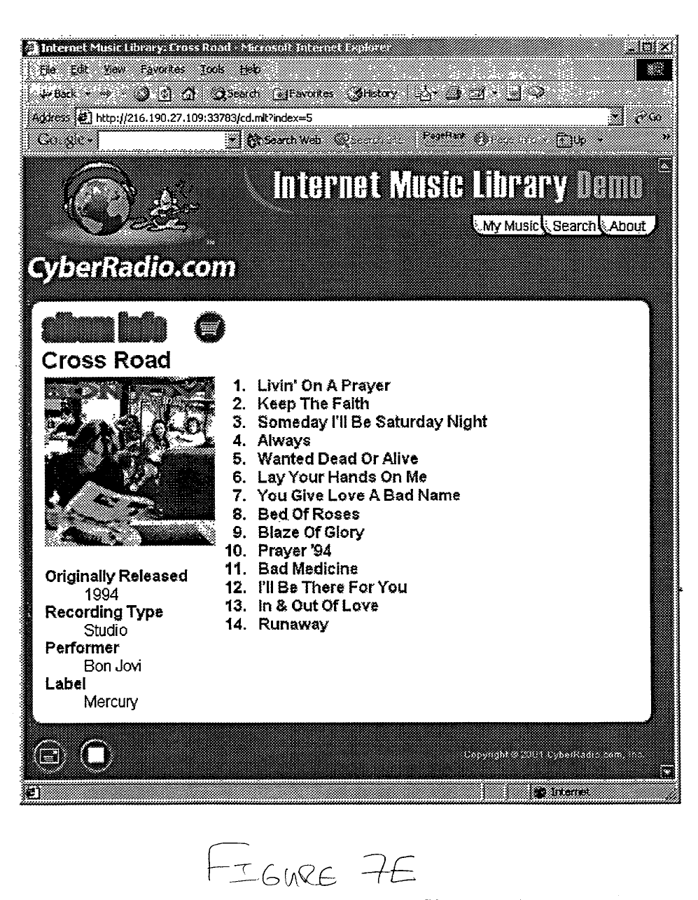

FIG. 5 is a flowchart of an exemplary process for retrieving a file from the database for distribution to a system user. Such processing typically takes place at a library system application 302, although alternate embodiments may share or spread processing between various client and server or between multiple server processors. With reference now to FIG. 5, an exemplary process 500 suitably begins with a customer/client/user contacting server 110 (step 502) via network 106. In an exemplary embodiment, the user suitably connects with a conventional web browser application such as Microsoft Internet Explorer or the like. Server 110 suitably provides a web page, HTML document or other interface to the user as appropriate. In various embodiments, server 110 also provides an interface for the user to enter a userid/password combination or another appropriate credential (such as a smartcard certificate, digital signature, or the like). An exemplary interface for obtaining userid/password information is shown in FIG. 7A. Alternatively, the login process may be bypassed if the user maintains a “cookie” or other identifying token on his/her computer that may be appropriately provided to server 1 10 for authentication.

With continued reference now to FIG. 5, server application 302 suitably processes the information obtained to determine (i.e. validate) if the user is authorized to use the library system 300 (step 504). Processing of new and existing user accounts may be handled by account manager module 314, as appropriate, and in conjunction with security mechanisms provided by web server 310. If the user is a new user of the system, a new user account may be created (step 506) and information about the user (such as identifying information, optional demographic information, and optional payment information such as a credit card number and expiration date) may be obtained, as described more fully above. If the user is not authorized or recognized, access to server system 300 may be blocked at web interface 310, or at another appropriate point. If the user is recognized and authorized to use the system, processing continues as described below. In various embodiments, certain users may be permitted to have limited access to system functionality without obtaining accounts with system 300. Such limited functionality may include access to a search engine, to low-quality content, to non-copyrighted or public domain content, to content that is being specially promoted, to abbreviated or shortened clips of certain content, or the like.

After a user is appropriately identified and authorized to use library system 300, processing suitably proceeds to allow users to search and identify content stored in database 116 in which the user holds an interest (step 508). Users may be prompted with a search interface such as that shown in FIG. 7B, for example, or with any other interface that allows the user to browse, search or otherwise identify and retrieve items of interest in database 116. Such a search engine or interface may be implemented by distribution module 316 or another portion of server application 302, as appropriate. In the exemplary interface shown in FIG. 7B, a user has entered an artist's name and has received the names of tracks in database 116 performed by that artist. FIGS. 7D and 7E provide additional exemplary views of interface screens providing additional information about a particular user selection corresponding to a record album.

Of course other embodiments may include searches based upon music genre, artist name, track name, album name or the like. Similarly, libraries holding different types of content may include different search fields as appropriate. A library of movies, for example, might include searchable fields for title, actors' names, awards won, type of movie (i.e. action, comedy, mystery, etc.), director's name, and the like. Different embodiments will include widely varying interfaces and mechanisms for granting access to content stored in the database. In one alternate embodiment, for example, content may be “suggested” to a user based upon preferences provided by the user, past content selections, or the like. Various user interfaces may also include advertising materials as appropriate, and these advertising materials may, in some embodiments, be tied to user preferences or selection histories such that ads may be appropriately targeted to the most effective recipients.

With reference again to FIG. 5, processing continues after the user has identified content of interest by providing access to the authorized user as appropriate (step 522). Access may be provided though file transfer, streaming audio/video, low resolution, or any other manner depending on the users' desire and the particular embodiment employed. In various embodiments, users listen/view content from database 116 via a client program residing and executing on the users' computer. Such a client program may use the users' browser as a user interface, and may reside as an applet, ActiveX control, or the like. Alternatively, the client program may be a free-standing application with its own interface display. Various embodiments of the client program suitably include a media player (such as an MP3 or Vorbis player, movie player, or the like). Alternatively, the client program may inter-operate with an external media player residing on the users' computer such as Windows Media Player, RealPlayer (available from RealNetworks Inc.) or the like.

Before server application 302 transfers content from database 116 to the user, distribution module 316 (or another appropriate module) suitably encrypts the content to prevent unauthorized copying/redistribution (step 520). This encryption takes place at server application 302 after the user identifies a desired content item, and may be implemented with any encryption algorithm such as DES, RSA, or the like. In an exemplary embodiment, the encryption key is based upon a unique identifier provide by the client application to server application 302. This unique identifier may be associated with a physical or logical component of the users' computer that is very difficult to modify such as the processor serial number, date that the users' root file system was created, MAC address, or the like. Such an encryption algorithm may make use of self-modifying code to prevent reverse engineering of the key, which could allow for unauthorized duplication of content received. Content may also be encoded with an expiration date such that the file cannot be decrypted or played back after a specified date or after a certain period of time has elapsed.

In various embodiments, distribution module 316 also adjusts a counter associated with the number of copies available for distribution to ensure that an appropriate license is available for the copy downloaded by the user (step 520). As described more fully above and below, various aspects of the library will ensure that only a limited number of copies of each content item may be simultaneously “loaned” to users. When the limit of available copies is reached, subsequent downloads/listens may be disabled by server application 302. This counter, in conjunction with encryption preventing unauthorized copying, suitably prevents unauthorized copying or re-distribution and allows for proper maintenance of licenses/permissions from server system 300.

With reference again to FIG. 5, if previewing is desired (step 514), a low-resolution or shortened clip of the content may be provided as appropriate (step 510). In an exemplary embodiment, a user may be prompted to view a low resolution preview prior to downloading/viewing the file. Such a preview may be provided with or without cost to the user, and may assist the user in determining whether he or she is interested in obtaining the entire file. Similarly, data streams may be provided if desired (step 518) by encrypting the content as described above and providing the data stream according to any convenient scheme (such as the Vorbis streaming technique, or via any other streaming technology).

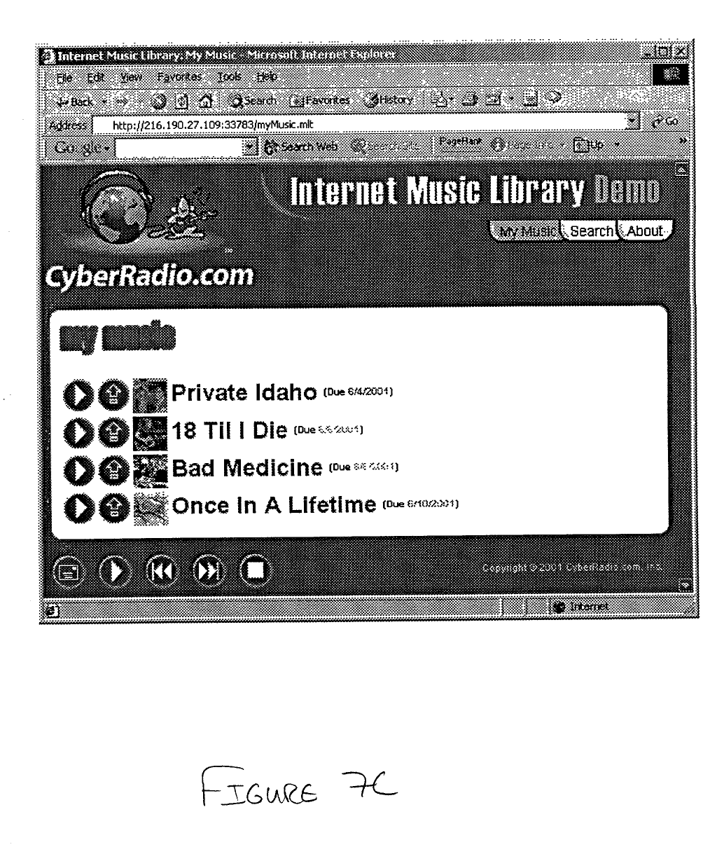

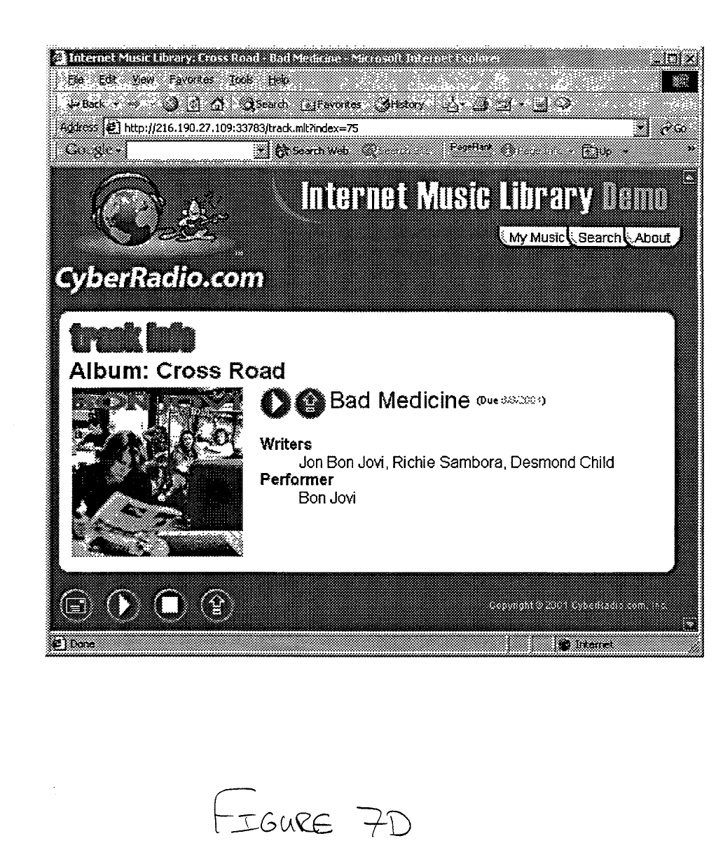

FIG. 6 is a flowchart of an exemplary process executed by a client application running at a user's computer. Such a process typically begins with a user contacting server application 302 via network 116 to view items that have been checked out. An exemplary user interface for this screen showing titles checked out (along with associated due dates) is shown in FIG. 7C. Retrieving information about checked out items may require logging into server application 302 as described above. Alternatively, information may be provided locally such that access to network 106 is not required for playback. In such embodiments, an interface similar to that shown in FIG. 7C may be presented by the client application or by a local browser.

With continued reference to FIG. 6, the playback process suitably begins by initializing the client application (step 602). Initialization typically includes activating the client application and establishing any appropriate connections to browser/interface applications and one or more playback programs such as an audio player. Initialization continues by determining if any of the checked out files have expired (step 604) and processing any expired files as appropriate (step 606). Expired files may be processed by disabling and/or deleting the content file, by notifying server application 302 of the expiration, by purchasing the content, and/or the like. The client application may also identify any nearly expired files (such as those expiring the next 2-3 days, or any other period of time) (step 608) and appropriately notify the user (step 610). The user may then be prompted to return the file, to purchase the file, or the like (step 612). If the user desires to return the file, client application suitably notifies server application 302 as appropriate.

Playback (step 618) of audio, AN and other files suitably involves loading the encrypted file into memory, decrypting the file, and passing the decrypted information to a playback application. As stated above, encryption is typically processed using an attribute of the user's computer to prevent playback on other computers. The client application appropriately obtains the requisite key information to decrypt the file, and checks the expiration date of the file prior to playback. Assuming that decryption is successful and the file is not expired, playback takes place via any suitable playback application.

It will be appreciated that the systems and methods described above suitably respect the needs of content consumers and providers. Content is appropriately obtained in a desired digital format, along with a counter of available copies of the content that are available for simultaneous consumption. As users are authenticated and allowed to check out content items from the library database, the counters may be adjusted and subsequently checked to ensure that the number of copies “checked out” at any particular time does not exceed the number of available copies. Checked out copies may be encrypted with a key that is specific to the computer receiving the file so that any subsequent copying or redistribution will be unsuccessful. Copies may also be encoded with an expiration date so that access to the file is disabled after a limited period of time. In such a manner an online library for distribution of digital content may be provided. Such a system (and associated methods) provide great opportunities for cooperation within the digital media industry as artists/content creators, distributors (e.g. record labels), technologists and consumers' needs are simultaneously met. Accordingly, an ownership scheme involving joint ownership by artists, distributors, technologists and the like could be formulated. For example, ownership of the library system could be apportioned between artists, content distributors and technologists according to any distribution scheme. Such an ownership model would further improve cooperation between those segments of the entertainment industry that were previously at odds with each other.

It will be appreciated that library systems such as those described herein may become profitable though any pricing/cost scheme. Users could be charged for access on a daily/weekly/monthly/annual or other basis, for example, or “per transaction” charges could be assessed for files or bytes downloaded, or according to any other scheme. In one exemplary embodiment, users are charged a signup fee in addition to a flat monthly fee for the use of the library service. Artists or distributors could be charged for the privilege of distribution and promotion of their works according to any time-based, “per download” or other scheme. Advertising could be provided to users, and advertisements may be targeted toward particular users based upon their demographic information, pre-selected preferences, past or present content selections, or the like. Further, it will be understood that the terms “user”, “consumer” and “customer” as used herein may apply to individuals as well as corporate entities such as radio stations, promoters, record companies, A&R services, or the like. In one embodiment, for example, a library may be formulated to provide digital music to radio stations (including Internet radio stations and/or “brick-and-mortar” radio stations). In such an embodiment, radio stations suitably register as users of the library to receive songs provided by record labels, artists or the like. Stations may be charged any amount such as a weekly/monthly fee and/or a per-download fee. In an exemplary embodiment, stations are charged between $5 and $1000 per month, such as approximately $50/month for the library service. Additional detail about promotion of digital content is contained in U.S. patent application Ser. No. 09/785,613, entitled “System and Method for Promoting Audio Content Via A Digital Network” filed Feb. 16, 2001 and incorporated herein by reference. The technologies disclosed therein may be combined with the digital library to create a library of promotional materials that may be marketed to one or more radio stations or other appropriate consumers.

Various embodiments of the library may be promoted to users/consumers by any technique, including advertisements in print or broadcast media, Internet banner ads, targetted or un-targetted email campaigns, advertisements on similar Internet sites, or the like. Various embodiments include promotion of the library with multimedia emails incorporating MIME, HTML, Java, ActiveX or similar components incorporating voice, sound, moving images, video and /or other multimedia content. Such emails may be created with any multimedia software.

Of course many other embodiments and applications of a digital library may be formulated. In a further embodiment, kiosks may be provided in music stores or other locations whereby users may select files from the library and create their own compilation albums based upon content selected. Such embodiments may not necessarily include expiration dates, and users may be charged accordingly for unrestricted access to library resources. In such embodiments, users may be charged on a per song, per compilation or other basis. Such kiosks may further include a CD “burner” or other output so that users may keep a portable copy of the compilation created.

No elements of the invention described herein are necessary to the practice of the invention unless specifically described herein as “essential” or “required”. Of course other embodiments and applications of the system and technique may be formulated without departing from the scope of the present invention. The corresponding structures, materials, acts and equivalents of all elements in the claims below are intended to include any structure, material or acts for performing the functions in combination with other claimed elements as specifically claimed. The scope of the invention should be determined by the appended claims and their legal equivalents, rather than by the examples given above. The steps recited in any method claims may be practiced in the order recited, or in any other order.

What is claimed is:

1. A method of distributing digital content via a digital network, the method comprising the steps of:
receiving a request at a server for said digital content from a user via said digital network;
processing said request at said server to determine that said user is permitted to access said digital content; and
providing access for said digital content to said user via said digital network for a limited period of time, wherein said user is denied access to said digital content after said limited period of time has elapsed.

2. The method of claim 1 wherein said step of providing access comprises granting access to a data stream from said server to said user.

3. The method of claim 1 wherein said step of providing access comprises providing a data file from said server to said user.

4. The method of claim 3 wherein said step of providing access comprises encrypting said data file prior to transmittal to said user.

5. The method of claim 4 wherein said encrypting step comprises encrypting said data file such that access to said file is disabled after said limited period of time has elapsed.

6. The method of claim I further comprising the step of providing a preview of said digital content to said user prior to said providing access step.

7. The method of claim 5 further comprising the step of providing a preview of said digital content to said user prior to said providing access step.

8. The method of claim 1 further comprising the step of inputting said digital content to said server prior to said receiving step.

9. The method of claim 8 further comprising the step of maintaining a counter at said server wherein said counter corresponds to a number of copies of said digital content available for distribution.

10. The method of claim 9 wherein said step of processing said request comprises checking said counter to determine if said digital counter is available for distribution to said user.

11. The method of claim 9 further comprising the step of adjusting said counter after said providing access step to reflect that said copy of said digital content provided to said user is not available for other users.

12. The method of claim 11 further comprising the step of adjusting said counter after said limited period of time has elapsed to reflect that said copy of said digital content provided to said user is available for other users.

13. The method of claim 8 further comprising maintaining a counter at said server, wherein said counter corresponds to a number of users having simultaneous access to said digital content.

14. The method of claim 13 further comprising the step of incrementing said counter as additional copies of said digital content are input to said server.

15. The method of claim 13 further comprising the step of adjusting said counter as said user receives access to said digital content.

16. The method of claim 15 further comprising the step of re-adjusting said counter after said limited period of time has elapsed.

17. A digital storage medium having instructions stored thereon, wherein said instructions are configured to execute the method of claim 1.

18. A digital storage medium having instructions stored thereon, wherein said instructions are configured to execute the method of claim 8.

19. A digital storage medium having instructions stored thereon, wherein said instructions are configured to execute the method of claim 12.

20. A digital storage medium having instructions stored thereon, wherein said instructions are configured to execute the method of claim 16.

21. The method of claim 1 further comprising billing said user for the use of said server according to a billing scheme.

22. The method of claim 21 wherein said billing scheme comprises an initiation fee for initializing an account with said server.

23. The method of claim 21 wherein said billing scheme comprises a periodic fee.

24. The method of claim 21 wherein said billing scheme comprises a per-item fee.

25. A system for distributing digital content via a digital network, the system comprising:
a database configured to receive said digital content and to store said content;
an interface to said digital network; and
an application program configured to receive a request for said digital content from a user via said interface and to process said request such that said user is granted access to said digital content for a limited period of time via said interface.

26. The system of claim 25 wherein said application program further comprises a counter, said counter corresponding to a number of instances of said digital content available for access from said server.

27. The system of claim 26 wherein said application program is further configured to adjust said counter when said user is granted access to said digital content, and to re-adjust said counter after said limited period of time has expired.

28. The system of claim 25 wherein said application program is further configured to encrypt said digital content prior to distribution to said user.

29. The system of claim 28 wherein said digital content is encrypted such that access to said digital content is disabled after said limited period of time has expired.

30. The system of claim 27 wherein said application program is further configured to encrypt said digital content prior to distribution to said user.

31. The system of claim 30 wherein said digital content is encrypted such that access to said digital content is disabled after said limited period of time has expired.

32. The system of claim 25 further comprising an accounting application configured to maintain an account for said user.

33. The system of claim 32 wherein said account comprises payment information, and wherein said accounting application is further configured to bill said user according to said payment information.

34. The system of claim 33 wherein said accounting application is configured to charge a periodic fee for continued access to said system by said user.

35. A method of operating an online library, the method comprising the steps of:
maintaining a database comprising digital content and an accounting of a number of acceptable simultaneous consumers of said digital content;
accepting requests from users for access to said digital content; and
granting said users access to said digital content in response to said requests if said number of acceptable simultaneous consumers is not exceeded.

36. The method of claim 35 wherein said access granted is restricted to a limited period of time.

37. The method of claim 36 further comprising the steps of obtaining a plurality of copies of a source of said digital content and converting information from said plurality of copies of said source to create said digital content.

38. The method of claim 37 wherein said number of acceptable simultaneous consumers is a function of the number of said plurality of copies obtained.

39. The method of claim 38 further comprising the step of accepting returns of said digital content from said users.

40. The method of claim 39 further comprising the step of assessing a penalty upon said users if said digital content is not returned by the expiration of said limited period of time.

41. The method of claim 39 further comprising the step of charging said users for said digital content if said digital content is not returned by the expiration of said limited period of time.

42. The method of claim 39 further comprising the step of providing one of said plurality of copies to said user if said digital content is not returned by the expiration of said limited period of time.

43. A digital storage medium having computer-executable instructions stored thereon, wherein said instructions are configured to execute the method of claim 35.

44. A digital storage medium having computer-executable instructions stored thereon, wherein said instructions are configured to execute the method of claim 42.

45. A digital library system comprising:
an interface to a digital network;
a database comprising a digital content item; and
a server application configured to retrieve said digital content item from said database in response to a request from a user, to encrypt said digital content item, and to provide said digital content item to said user via said interface.

46. A digital library system of claim 45 further comprising a counter corresponding to a number of copies of said digital content item available for simultaneous checkout.

47. A digital library system of claim 46 further wherein said server application is further configured to check said counter prior to providing said digital content item to said user to ensure that the number of checked-out copies of said digital content item does not exceed said counter.

48. A digital library system of clam 45 wherein said server application is further configured to encrypt said digital content item such that an encryption key is based upon an identifying characteristic of said user.

49. A digital library system of claim 48 wherein said characteristic is a date of file system creation.

50. A digital library system of claim 48 wherein said characteristic is a MAC address.

51. A digital library system of claim 48 wherein said characteristic is a processor serial number.

52. A digital library system of claim 48 wherein said user is a radio station.

53. A digital library system of claim 48 wherein said digital library system is jointly owned by at least one artist, at least one content distributor, and at least one technologist.

54. A digital library system of claim 48 wherein said user is prompted to create a digital compilation comprising said digital content item.

55. A digital library system of claim 54 wherein said user is prompted by a kiosk.
